(19) United States
(12) Patent Application Publication
(10) Pub. No.: US 2005/0105235 A1
(43) Pub. Date: May 19, 2005

(54) Surge protector

(76) Inventor: Jeff Yu, San Jose, CA (US)

Correspondence Address: Richard C. Liu, 39 MIRAMONTE DR., MORAGA, CA, 94556, US

(21) Appl. No.: 10/706,098

(22) Filed: Nov. 13, 2003

(51) Int. Cl. H02H 9/06

(52) U.S. Cl. 361/118

(57) ABSTRACT

A power strip having multiple receptacles contains a replaceable surge protection module removably attached to the device body. On one preferred embodiment, an ON/OFF switch is provided for easy electricity cutoff to the receptacles of this power strip. A portion of the power strip has a recess with multiple prong holes configured to receive the surge protection module. The protection module has multiple prongs for insertion into the multiple prong holes. In addition to the surge protection the module provides, the electrical configuration for the present invention is such that if the protection module is not inserted and therefore not electrically connected into the power strip, no electricity will flow to the multiple receptacles in the power strip even if the ON/OFF switch is turned ON.

### TECHNICAL FIELD

The present invention relates generally to a surge protector removebly attached to a power extension device. More in particular, the present invention relates to a surge protector module removably attached to a power strip, and when attached, helps to prevent the associated electronic equipment from sudden electrical surges. The attach-on surge protector module contains built-in electronics such as surge protection circuitry. The entire protector module could be easily replaced in the case of electronics failure after current spikes or voltage surges.

### BACKGROUND ART

It is well known that a variety of power extension devices with electrical surge protection have long been used for the protection of electrical equipment from electrical spikes that occur from time to time in power lines. Each surge protection device typically serves one or more electrical devices that are deemed to be particularly important to protect, usually because of the expense and the replacement/maintenance problems that can result from the equipment being taken out of service.

One typical implementation discloses a surge protection device being integrated with and embodied inside a power strip whereby protecting the receptacles of that power strip. Accordingly, this protection device is not capable of being readily removable and therefore, once the surge protection device is triggered and used, the replacement cost for the device would uneconomically include the cost of another power strip. Many power strips even contain only thermo-fuses as a part of surge protection. As a result, the power strips are capable of delivering electricity to attached electrical equipment even after electrical surges had knocked out their surge protection circuitry. Such power strips rely on the users to respond to the appropriate visual surge protection indicators by replacing the power strips. For such configuration especially when they are placed in obscure and difficult-to-reach comers where visual indicators for surge protection are not easily visible, they invariably present a false sense of comfort to users and risks to the attached electrical equipment.

One other typical implementation discloses a surge protection device as incorporated as a part of the receptacle wall plate for a wall outlet. The disadvantage is that any replacement of the surge protection device after use would require the replacement of the outlet wall plate as well.

Another implementation discloses a surge protection device being “sandwiched” by an electrical outlet (e.g., a wall outlet, a power strip) and the plug of an appliance being protected. More specifically, an electrical appliance for which surge protection is sought is plugged into a receptacle provided on the backside of the surge protection device. Prongs on the front side of the surge protection device are then plugged into an electrical outlet to electrically connect the electrical appliance to the power line. The surge protection elements of the device protect the electrical appliance from transient voltage surges on the power line. Disadvantageously, the size of the combination resulting from coupling the appliance with the surge protection device often is too bulky. Therefore, it does not provide sufficient room for other electrical appliances to be plugged into the receptacles of the electrical outlet that are immediately adjacent to the receptacle where the combination is connected.

A need therefore exists for providing a power extension device such as a power strip with a surge protection module that is readily accessible for removal ease and replacement convenience. Another need also exists for ensuring the cut off of electricity after the voltage spikes and surges had knocked out the surge protection circuitry. Such a device should also be easily replaced with as economical a cost as possible.

### SUMMARY OF THE PRESENT INVENTION

Accordingly, It would be desirable and therefore an object for the present invention such as a power extension device to provide a surge protection module that is readily accessible for removal ease and replacement convenience. It is another object for the present invention to be easily replaceable with as economical a cost as possible. Additional objects and advantages of the present invention will be set forth in the description that follows, and in part, will be obvious from the description or may be learned by practice of the invention.

Briefly, a power extension device such as a power strip having multiple receptacles contains a replaceable surge protection module removably attached to the body of the device. The power strip has a generally elongated and rectangular housing body. On one preferred embodiment, an ON/OFF switch is provided for easy electricity cutoff to the receptacles of this power strip. A portion of the power strip has a recess with multiple prong holes configured to receive the surge protection module. The protection module has multiple prongs for insertion into the multiple prong holes. The electrical circuitry for a typical power strip is well known, and the electrical configuration for the present invention is such that if the protection module is not inserted and therefore not electrically connected into the power strip, no electricity will flow to the multiple receptacles in the power strip even if the ON/OFF switch is turned ON. Further as another aspect of the invention, no electricity will flow to the power strip once after the surge protection circuitry is knocked out by electrical surges and voltage spikes whereby affording no more surge protection for any attached electrical equipment. In these cases, a replacement module must be inserted into the power strip in order to again use the power strip.

Accordingly, the present invention provides a surge protection device that is readily accessible for removal ease and replacement convenience. It further provides a surge protection replacement with as economical a cost as possible. Additional objects and advantages of the present invention will be set forth in the description that follows, and in part, will be obvious from the description or may be learned by practice of the invention.

### BRIEF DESCRIPTION OF THE DRAWINGS

A better understanding of the present invention can be obtained by considering the following detailed description taken together with the accompanying drawings that illustrate preferred embodiments of the present invention in which:

FIG. 1 is a perspective view of a preferred embodiment of the present invention with its surge protection module attached;

FIG. 2 is another perspective view of the preferred embodiment of the present invention without its surge protection module attached;

FIG. 3 is a top view of the preferred embodiment of the present invention without its surge protection module attached whereby exposing its multiple module prong receiving holes;

FIG. 4 is a top view of a surge protection module of the preferred embodiment of the present invention;

FIG. 5 is a bottom view of the surge protection module of the preferred embodiment of the present invention; and

FIG. 6 is a circuit diagram illustrating a surge protection device inside the module of the present invention.

### DETAILED DESCRIPTION OF THE PREFERRED EMBODIMENTS

With today's state in surge protection device technology, any surge protector designs generally do not require the rendering of fully detailed implementation diagrams. The definition of mechanical and electrical functionality allows those skilled in the art to design the surge protection implementations. Accordingly, functionality will be described in detail with the accompanying drawings. Those of ordinary skill in the art, once given the following descriptions of the various aspects of the present invention will be able to implement the necessary mechanical and electrical arrangements in suitable technologies without undue experimentation.

Reference will now be made in detail to the preferred embodiments of the present invention, examples of which are illustrated in the accompanying drawings. While the invention will be described in conjunction with the preferred embodiments, it will be understood that they are not intended to limit the invention to those embodiments.

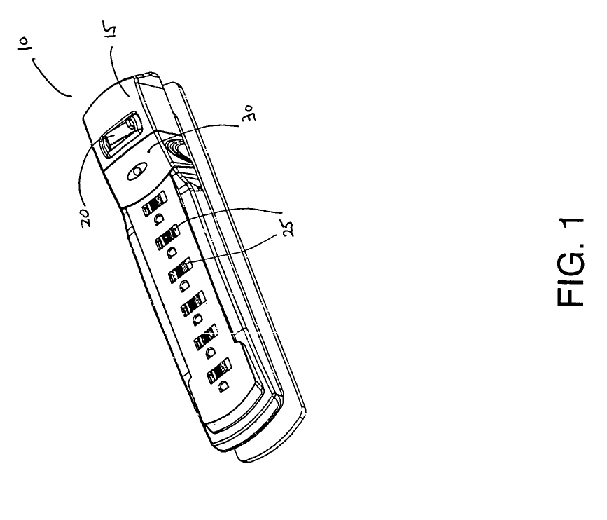

FIGS. 1-3 illustrate a preferred embodiment of the present invention. The embodiment 10 has a generally elongated and rectangular housing body 15, an ON/OFF switch 20, multiple plug receptacles 25 and a surge protection module 30. The housing body 15 may be made of plastics, metal or other moldable materials. The ON/OFF switch 20 is designed to allow or disallow electricity from flowing to the multiple plug receptacles 25 of the embodiment 10. Assuming that the surge protection module 30 is inserted and that the surge protection is available, if the switch 20 is ON, the equipment that are plugged into the receptacles 25 will receive electricity. Otherwise, electricity will not flow to the attached equipment.

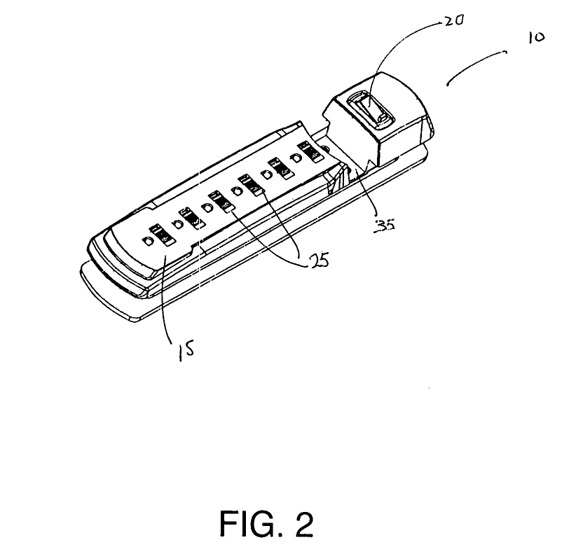

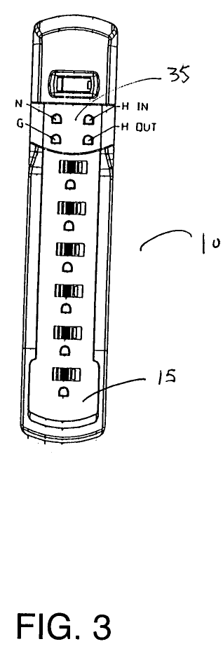

More specifically for the drawings, FIG. 1 illustrates a perspective view of the preferred embodiment 10 of the present invention with its surge protection module 30 attached whereas FIGS. 2 and 3 illustrate two views of the preferred embodiment 10 with the surge protection module 30 unattached. Further, FIG. 2 shows a recess portion 35 configured to receive the surge protection module 30, and FIG. 3 shows four prong receiving holes (H IN, H OUT, N and G) in a recess portion 35 of the preferred embodiment 10.

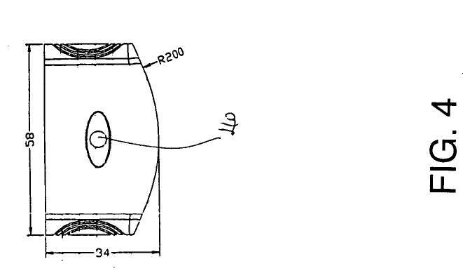

FIG. 4 shows the surge protection module 30 having an indicator LED 40 to indicate surge protection status. For example, a green light indicates the protection is available whereas a red light or no light indicates a lack of surge protection for the embodiment 10. Another example simply includes an ON LED light for surge protection availability and an OFF LED for the lack thereof. The overall shape of the surge protection module 30 may be various as long as that it is configured to fit into the corresponding recess portion 35. Also the electrical circuit inside the embodiment 10 and the module 30 may be configured in a way such that the recess portion 35 may be located anywhere in the housing body 15, either toward either end or the middle of the housing body 15.

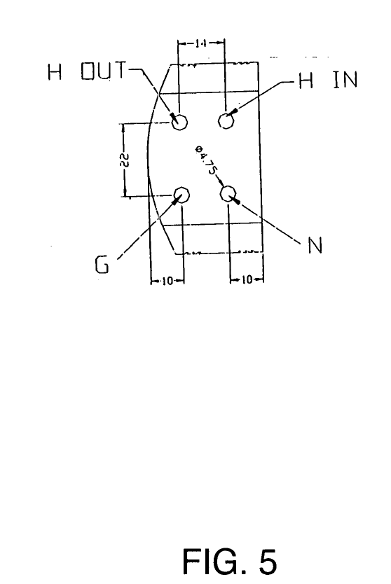

FIGS. 4 and 5 illustrate top and bottom views of the surge protection module 30. It has four prong pins (H IN, H OUT, N and G) that correspondingly match the four prong receiving holes (H IN, H OUT, N and G) of the recess portion 35 of the housing body 15. Operationally, when the surge protection module 30 is inserted into the recess portion 35 and into the four correspondingly matching prong-receiving holes (H IN, H OUT, N and G), electrical connection is made and surge protection for the embodiment is then available. However, if the module 30 is removed from the four prong receiving holes (H IN, H OUT, N and G), the electrical connection is no longer made and in fact as to be explained later that no electricity will be available to the multiple receptacles 25 of the embodiment 10.

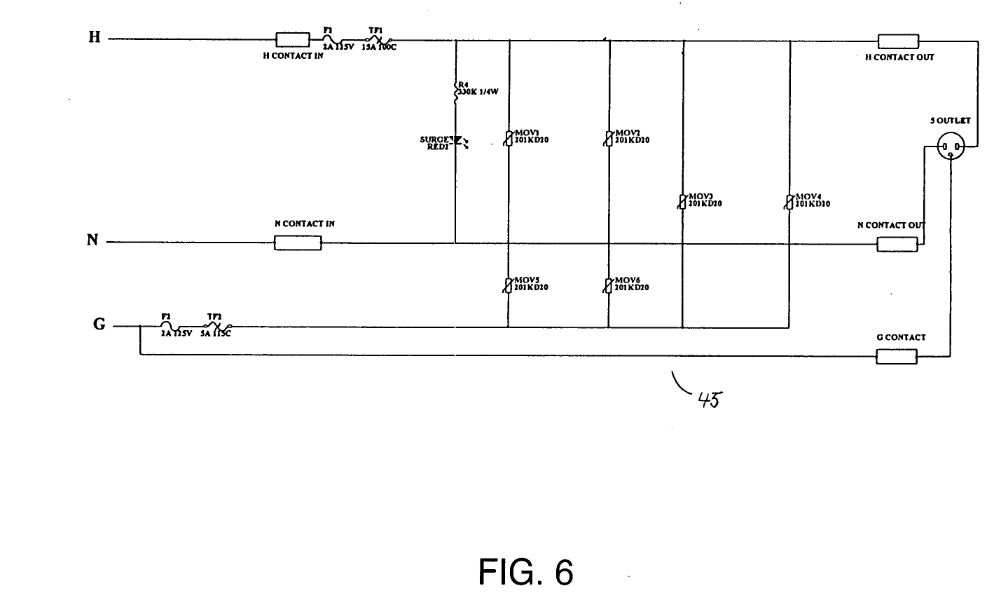

Referring now more specifically to FIG. 6, it is a circuit diagram illustrating the surge protection circuitry 45 of the embodiment 10 of the present invention. The circuitry 45 is disposed inside the surge protection module 30. The circuitry is well known to the artisans and therefore will not be further elaborated as to its detailed operations. However, briefly, it is worthwhile to point out that it 45 has a H line, a N line and a G line electrically connected, respectively, to the hot, neutral and ground lines of the wall outlet (OUTLET) and to the multiple receptacles 25 (not shown) of the embodiment 10 during operation. The circuit 45 also contains rectangular boxes to indicate where H IN, H OUT, N and G prong pins of the module 30 will make contact with the H, N and G lines respectively. As indicated earlier, if the module 30 is removed from the embodiment 10, the H line from the OUTLET will no longer be connected to the H line that goes to the multiple receptacles 25 of the embodiment 10 whereby making electricity unavailable to the receptacles 25 and any electrical equipment attached thereto.

The circuit 45 may further include capacitor elements (not shown) disposed in electrical parallel with one or more of the varistors MOV1 to MOV6 for EMI and/or RFI removal. The suitable values for these capacitors can be easily obtained without undue experimentation.

Generally speaking, the varistors MOV1 to MOV6 are preferred be metal oxide varistor, and they are nonconductive so that they generate open circuits when normal voltages are applied to the electrical outlet. However, when voltage surges occur at levels above normal voltage levels, the varistors become immediately conductive, and they establish short circuits that divert the voltage surges away from the electrical appliances or devices plugged into the electrical outlet at the time. And in that case, one or more varistor connections form open circuits. During normal operation, the LED circuit SURGE RED2 provides light emission as a status indicator.

In the case where the varistors MOV1 to MOV6 do not respond properly especially when voltage surges climb gradually and steadily, the fuse elements F1, TF1, F2, TF2 which normally act as a short circuit will in that case respond by burning the line into an open circuit. As a result, the LED circuit SURGE RED2 goes OFF and indicates to users that attention is needed for appliance inspection. Generally, fuse elements may be disposed in series on any of the three lines (H, N, or G line) and in terms of construction, the fuse elements may be a fuse, a melt-able conductor or a fuse-like resistor.

While the present invention has been described in terms of several preferred embodiments, it is contemplated that persons reading the preceding descriptions and studying the drawing will realize various alterations, permutations and modifications thereof. It is therefore intended that the following appended claims be interpreted as including all such alterations, permutations and modifications as fall within the true spirit and scope of the present invention.

1. A power extension device comprising:
a device body including a housing having at least one plug receptacle;
said housing having a recess portion for receiving a removably-attached surge protection module; and
said module containing surge protection circuitry being configured to prevent electricity flow when removed.

2. The power extension device recited in claim 1 wherein the housing of the device body being generally elongated.

3. The power extension device recited in claim 1 wherein the housing of the device body being generally rectangular in shape.

4. The power extension device recited in claim 1 wherein the recess portion of the housing of the device body being located toward an end of the device.

5. The power extension device recited in claim 1 wherein the recess portion of the housing of the device body being located toward the middle of the device.

6. The power extension device recited in claim 1 wherein the surge protection module position thereon at least one LED for indicating status.

7. The power extension device recited in claim 1 wherein the surge protection module having four inserting prongs.

8. A power strip device comprising:
a device body including a generally elongated and rectangular housing having multiple plug receptacles;
said housing having a recess portion located toward an end of the device body for receiving a removably-attached surge protection module; and
said module having positioned thereon at least one LED for status indication, said module further containing surge protection circuitry being configured to prevent electricity flow when removed.
